(19) United States
(12) Patent Application Publication
(10) Pub. No.: US 2004/0085265 A1
(43) Pub. Date: May 6, 2004

(54) Low power consumption PDP with high speed response

(75) Inventor: Joung-Hyun Yeo, Suwon-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/694,842

(22) Filed: Oct. 29, 2003

(30) Foreign Application Priority Data
Oct. 31, 2002 (KR) 2002-67199

(51) Int. Cl. G09G 3/28

(52) U.S. Cl. 345/60

(57) ABSTRACT

A plasma display apparatus with low power consumption and high speed response is disclosed. The plasma display apparatus includes: a plasma display panel driven by discharge sustain voltage in the form of pulses; an analog-digital converter digitizing image signal inputted from the external; a plasma display panel drive unit converting the digitized image signal into scanning pulses and data pulses driving the plasma display panel and outputting these pulses to the plasma display panel; a power supply unit supplying the discharge sustain voltage to the plasma display panel drive unit; and a controlling unit adjusting the output gain of the analog-digital converter in response to the variation of the output voltage of the power supply unit. With this plasma display apparatus, it is possible to quickly respond and reduce the power consumption occurring when the plasma display panel displays the high luminance of image signal.

### CROSS-REFERENCE TO RELATED APPLICATIONS

This application claims the benefit of Korean Application No. 2002-67199, filed Oct. 31, 2002, in the Korean Intellectual Property Office, the disclosure of which is incorporated herein by reference.

### BACKGROUND

1. Field of the invention

The present invention generally relates to a plasma display apparatus and method, and more particularly to a plasma display apparatus with low power consumption and high-speed response characteristics.

2. Description of the Related Art

Plasma display apparatus is one type of display apparatus in which image data is restored by arranging a plurality of discharge cells in a matrix and selectively emitting these discharge cells, and each of the discharge cells constituting the plasma display apparatus requires a discharge sustain voltage for sustaining the discharge. Thus, each of the discharge cells constituting the plasma display apparatus is supplied with a high discharge sustain voltage, thereby causing a higher power consumption as compared with other display apparatus (for example, CRT, LCD).

FIG. 1 is a vertical sectional view of a discharge cell constituting a plasma display apparatus.

The discharge cell shown is an AC discharge cell having two glass substrates 10 and 11 opposed to each other, the upper substrate 10 being provided with discharge sustain electrodes 12 and 13, and the lower substrate 11 being provided with an address electrode 14. A dielectric layer 15 is formed between the discharge sustain electrodes 12 and 13, and a protect layer 17 consisting of MgO film over the dielectric layer 15 is formed. Also, between the discharge sustain electrodes 12 and 13 a discharge gas (for example, He, Ne, Ar, or mixture gas thereof) is filled under pressure, typically 300 to 400 Torr. Such a discharge cell emits light by the discharge generated between the discharge sustain electrodes 12 and 13 when the discharge sustain electrodes 12 and 13 provided in the upper substrate 10 are applied with high voltage pulses, and accumulates predetermined charges in the dielectric layer 15. Thereby, the voltage to be applied to the discharge sustain electrodes 12 and 13 may become low by the amount of charge accumulated in the dielectric layer 15. At this time, the amount of charges accumulated in the discharge sustain electrodes 12 and 13 is proportional to the dielectric constant of the dielectric layer 15, and the charge accumulated in the dielectric layer 15 is generally referred to as a wall charge.

FIG. 2 is a graph showing the discharge characteristic of the discharge cell shown in FIG. 1.

As shown, it can be seen from the graph that the discharge start voltage causing the discharge cell to emit the light is significantly much higher than the discharge sustain voltage. The discharge sustain voltage is a voltage that makes the discharge cell continuously emit light, and typically has a low voltage relative to the discharge start voltage by the voltage formed by the accumulated charges in the dielectric layer 15. This is an electrical characteristic of having the discharge cell, and the discharge sustain voltage becomes lower as the amount of the accumulated charges in the dielectric layer 15 constituting the discharge cell becomes greater.

FIG. 3 illustrates the structure of a commercial plasma display panel, and specifically show a perspective view of the plasma display panel that is broken down consisting of the discharge cell shown in FIG. 1. This structure includes discharge sustain electrodes 12a to 13c formed in parallel to each other in the discharge space generated by partitions 20a to 20d, and data electrodes that are faced to and in perpendicular to the discharge sustain electrodes 12a to 13c. The phosphors 21a to 21c formed between the partitions 20a to 20d are stimulated by an ultraviolet ray to generate a visible ray, the ultraviolet ray being discharged with the high-voltage pulses that are applied to the discharge sustain electrodes 12a to 13c as described in FIG. 1. Each of the partitions 20a to 20d is arranged in such a manner as not to be subjected to the visible ray generated by the each phosphor 21a to 21c.

On the other hand, unlike a general cathode ray tube (CRT), the plasma display panel having such a structure is driven in a digital method, because it represents images by the on/off operation of the each discharge cell constituting the panel. The CRT controls the phosphor's luminance intensity by linearly varying the intensity of the electron beam that is radiated into each of pixels, whereas the plasma display panel controls the phosphor's luminescence intensity by adjusting the discharge sustain period during which the discharge sustain voltage is applied thereto. Hereinafter, the brightness control of the plasma display panel and the corresponding power consumption will be explained with reference to drawings.

FIG. 4 is a view showing the luminance representation method of the plasma display panel.

In this figure, an abscissa indicates the time, and an ordinate indicates the number of horizontal scanning lines. The luminance representation method shown is the 8-bit luminance implementation method, in which case one field is divided into 8 sub-fields, each of the sub-fields including a reset period, an address period, and a discharge sustain period. The reset period is to initialize the plasma display panel, the address period is to select a certain location in the plasma display panel, and the discharge sustain period is to emit the light at the selected location in the plasma display panel. During the address period, the discharge electrodes 12 and 13 are applied with +50V and −150V, respectively. Thus, with the voltage difference between the discharge electrodes 12 and 13, the discharge cell emits the light over the discharge sustain period.

The discharge sustain period is set by selectively turning-on the sub-fields having different luminescence periods (for example, T1:T2:T4:T8: T16:T32:T64:T128), and has a specific luminance value depending on the turn-on state of the sub-fields having different luminance periods.

For example, to obtain the luminance value of the number ‘127’, the sub-fields from T1 to T7 may be sequentially turned on. That is, T1+T2+T4+T8+T16+T32+T64=T127. In this way, if using all of the eight sub-fields, it is possible to represent the luminance value of 256 (2⁸). The higher the luminance value of the image displayed in the plasma display panel, the longer the discharge sustain period, and hence the power supplied to the each discharge cell constituting the plasma display panel is increased to the extent that the discharge sustain period is long. Also, since the amount of the residual electric charges in each discharge cell increases as the luminance becomes higher, even if the discharge cell is turned-off, the image having been displayed does not immediately disappear. That is, an after image is generated.

FIG. 5 is a block diagram showing a conventional plasma display apparatus having APC (Auto Power Control) function.

The shown plasma display apparatus includes a decoder unit 30, an analog-digital converter (A/D converter) 40, a scaler 50, a plasma display panel drive unit 60, a plasma display panel (PDP) 70, and APC controlling unit 80.

The decoder unit 30 converts an image signal having a format other than the R, G, B format into an image signal of the R, G, and B format.

The analog-digital converter 40 is inputted with the image signal of the R, G, and B format from the decoder unit 30 or personal computer (not shown) and converts it into digital image signal.

The scaler 50 converts the digital image signal outputted from the analog-digital converter 40 to a screen size appropriate to the plasma display panel 70.

The plasma panel drive unit 60 is inputted with the digital image signal from the scaler 50 and converts it into a signal for driving the plasma display panel 70. For example, the plasma display panel drive unit 60 generates scanning pulses and address pulses for selecting the discharge cell constituting the plasma display panel.

The APC controlling unit 80 detects the luminance level of the image signal from the scaler 50 to the plasma panel drive unit 60, and when the detected luminance level is above a prescribed level, controls the plasma panel drive unit 60 and reduces the luminance level of the image signal inputted to the plasma display panel 70.

The APC controlling unit 80 comprises an APL (Average Picture Level) detection unit 81, a microcomputer (MCU) 82, and a look-up table 83.

The APL detection unit 81 reads the image signal outputted from the scaler 50 in one frame unit and calculates the average luminance value of the image signal.

The look-up table 83 stores the number of the discharge sustain pulses based on the average luminance value (APL) in a table format.

The MCU 82 reads the number of discharge sustain pulses stored in the look-up table 83 in response to the detected average luminance value and controls the plasma panel drive unit 60 based on the number read. Thereby, as the average luminance value detected by the APL detection unit 81 becomes high, the number of discharge sustain pulses supplied to the plasma panel drive unit 60 is reduced and the average luminance value of the image signal displayed in the plasma display panel 70 becomes low.

However, the above-described plasma display apparatus calculates the average luminance value in one frame unit, before performing the control on the plasma display panel drive unit 60 by the APC controlling unit 80, hence it is not possible to control the plasma panel drive unit 60 at an appropriate time. Also, there is a problem that separate hardware for calculating the average luminance value is required.

On the other hand, in order to reduce the power consumption of the plasma display apparatus, the method in which the variation of the power consumption in the plasma panel drive unit 60 is calculated and the discharge sustain voltage applied to the plasma panel drive unit 60 is controlled on the basis of the calculated variation of the power consumption has been disclosed in Japanese Patent Laid-Open No. 13-296835. This method comprises the steps of obtaining an average current value by a current detection means, converting the average current value into an average voltage value using an integrating circuit, digitizing the converted average voltage value and the average current value, comparing the average power value with a predetermined value, and increasing or decreasing the luminance level of the discharge cell constituting the plasma display panel 70. Also, since this method requires a multiplier for multiplying current value by voltage value to calculate the power value and controls the number the discharge sustain voltage is applied to the plasma panel drive unit 60 based on the calculation result, like the method shown in FIG. 5, the high-speed response characteristic degrades and separate complex hardware is required.

### SUMMARY

Therefore, the present invention is made in order to solve the problems described above.

It is therefore an aspect of the present invention to provide a plasma display apparatus with low power consumption and high speed response in which the configuration is simple and the reliability is high.

In order to accomplish the above aspect and/or other features of the present invention, a plasma display apparatus comprises: a plasma display panel driven by discharge sustain voltage in the form of pulses; an analog-digital converter for digitally converting image signal inputted from the external; a plasma display panel drive unit for converting the digitized image signal into scanning pulses and data pulses for driving the plasma display panel and outputting these pulses to the plasma display panel; a power supply unit for supplying the discharge sustain voltage to the plasma display panel drive unit; and a controlling unit for adjusting the output gain of the analog-digital converter in response to the variation of the output voltage of the power supply unit.

In an exemplary embodiment, the controlling unit comprises a voltage sensing unit for sensing the variation of the discharge sustain voltage, a voltage comparison unit for comparing the sensed voltage from the voltage sensing unit with a predetermined voltage, and a gain adjusting unit for adjusting the output gain of the analog-digital converter depending on the comparison results.

In an exemplary embodiment, the voltage sensing unit includes a first resistor and a second resistor connected in series between the discharge sustain voltage and a ground.

In an exemplary embodiment, the voltage comparison unit comprises an operational amplifier inputted with a predetermined voltage at its first input terminal, a third resistor connected between a node commonly connected to the first resistor and the second resistor and a second input terminal of the operational amplifier, and a fourth resistor between the output terminal of the operational amplifier and the input terminal of the gain adjusting unit.

In an exemplary embodiment, the gain adjusting unit includes a data storage unit for storing the gain value of the analog-digital converter, and a microcomputer (MCU) for supplying a predetermined voltage value to the second input terminal of the operational amplifier and outputting the gain value stored in the data storage unit to the analog-digital converter in response to the comparison result of the voltage comparison unit.

In an exemplary embodiment, the operational amplifier includes an analog operational amplifier.

In an exemplary embodiment, the MCU stores a predetermined voltage that is inputted to the operational amplifier.

In an exemplary embodiment, the discharge sustain voltage of the power supply unit is reduced with the increase of the luminance level of the image signal from the plasma display panel drive unit to the plasma display panel.

In an exemplary embodiment, the output gain of the analog-digital converter is reduced with the increase of the luminance level of the image signal that is inputted to the plasma display panel.

In an exemplary embodiment, the plasma display apparatus according to the present invention further comprises scaler that is positioned between the analog-digital converter and the plasma display panel drive unit and converts the digital image signal outputted from the analog-digital converter to an image size appropriate to the plasma display panel.

According to an exemplary embodiment of the present invention, a method for controlling the power of the plasma display apparatus having a plasma display panel driven by discharge sustain voltage comprises the steps of: converting image signal inputted from the external into digital image signal; and adjusting the output gain of the digitized image signal in response to the variation of the discharge sustain voltage.

In an exemplary embodiment, the step of adjusting the output gain comprises the steps of sensing the variation of the discharge sustain voltage, comparing the sensed voltage with a predetermined voltage, and adjusting the output gain of the digitized image signal depending on the comparison results.

In an exemplary embodiment, the discharge sustain voltage is reduced with the increase of the luminance level of the digitized image signal.

In an exemplary embodiment, the step of analog-digital converting further comprises the step of converting the digitized image signal to an image size appropriate to the plasma display panel.

### BRIEF DESCRIPTION OF THE DRAWINGS

The embodiments of the present invention will be explained with reference to the accompanying drawings, in which:

FIG. 1 is a vertical sectional view of discharge cell constituting a plasma display apparatus

FIG. 2 is a graph showing the discharge characteristic of the discharge cell shown in FIG. 1.

FIG. 3 is a perspective view of the broken down plasma display panel.

FIG. 4 is a view explaining the luminance representation method of plasma display panel.

FIG. 5 is a block diagram of a conventional plasma display apparatus having APC function.

FIG. 6 is a circuit diagram according to an exemplary embodiment of the present invention.

FIG. 7 is a schematic view explaining the operation principal of the gain adjusting unit in shown FIG. 6.

FIG. 8 is a flow chart showing an exemplary embodiment of the method for controlling the power of a plasma display apparatus according to the present invention.

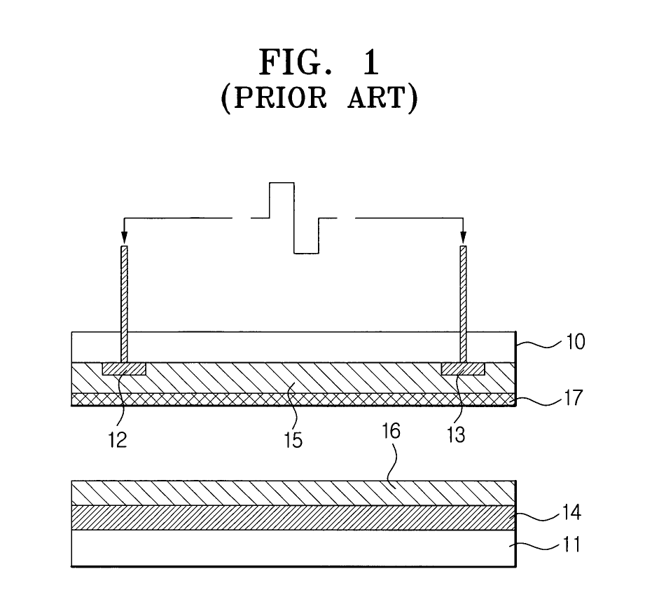

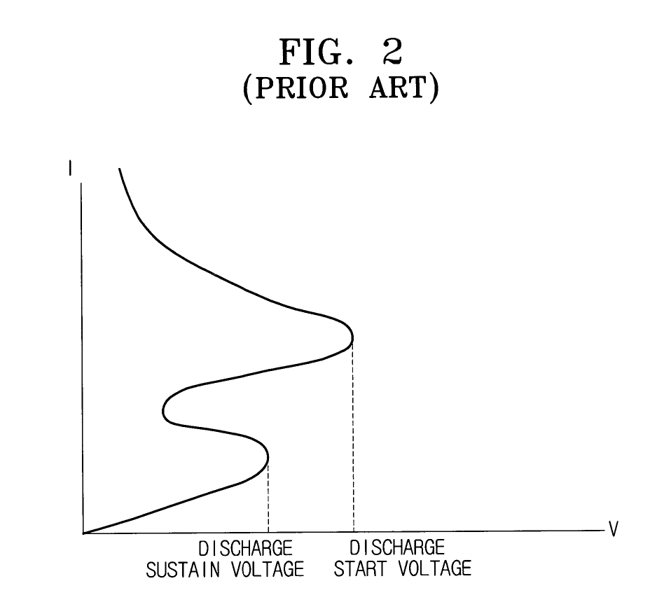

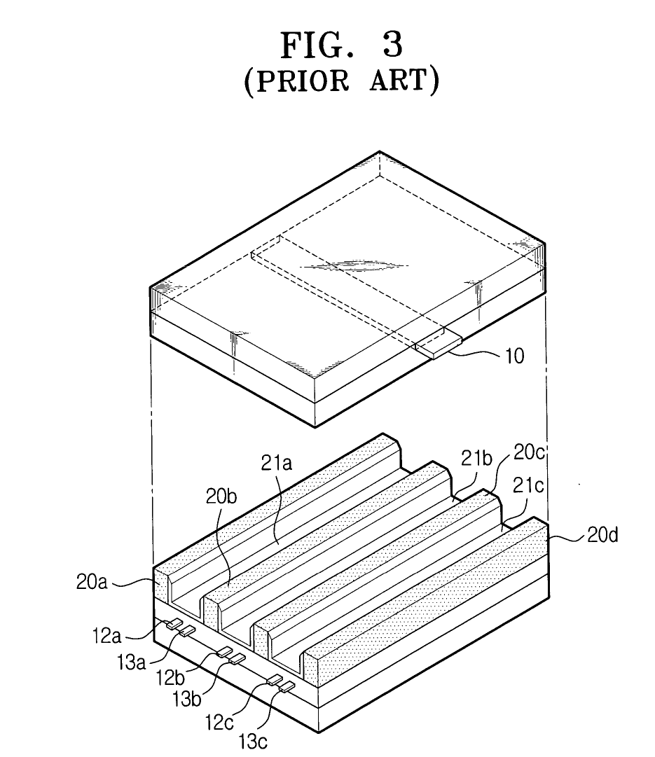

### DETAILED DESCRIPTION OF THE INVENTION

The above objects, other objects, features and advantages of the present invention will be better understood from the following description taken in conjunction with the attached drawings.

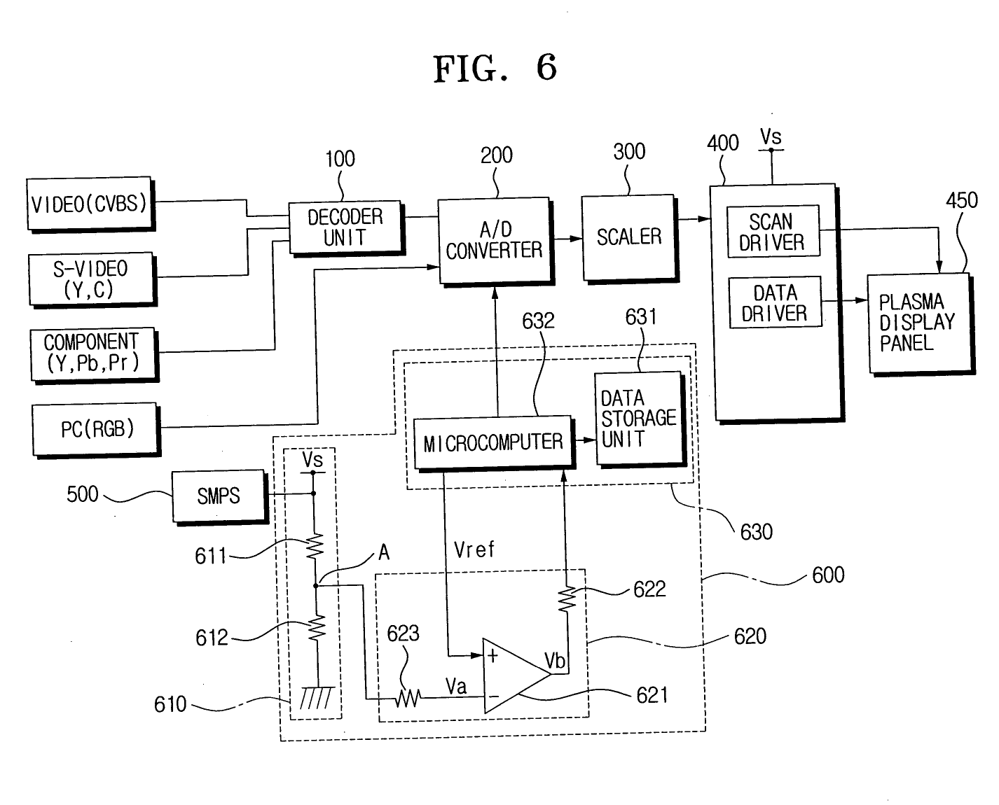

FIG. 6 is a circuit diagram according to an exemplary embodiment of the present invention.

The shown plasma display apparatus with low power consumption includes a decoder unit 100, an analog-digital converter (A/D converter) 200, a scaler 300, a plasma display panel drive unit 400, a plasma display panel 450, a power supply unit 500, and a controlling unit 600.

The decoder unit 100 converts an image signal of a format other than the R, G, and B format into an image signal of the R, G, and B formats.

The analog-digital converter 200 is inputted with the image signal of the R, G, and B format from the decoder unit 100 or personal computer (not shown) and converts it into a digital image signal.

The scaler 300 converts the digital image signal outputted from the analog-digital converter 200 to a screen size appropriate to the plasma display panel 450.

The plasma display panel drive unit 400 is inputted with the digitized image signal from the scaler 300 and converts it into a signal for driving the plasma display panel 450. For example, the plasma display panel drive unit 400 generates scanning pulses and address pulses (not shown) for selecting discharge cells (not shown) constituting the plasma display panel 450. Also, the plasma display panel drive unit 400 converts into the form of pulses the discharge sustain voltage Vs inputted from the power supply unit 500 in proportional to the luminance of the digital image signal inputted from the scaler 300 and outputs it to the plasma display panel 450. That is, it is possible to continuously apply the discharge sustain voltage in the form of pulses to each of the discharge cells constituting the plasma display panel 450 with the increase of the luminance of the digital image signal inputted from the scaler 300, resulting in enhancing the luminance of the image signal that is realized in the plasma display panel 450.

The power supply unit 500 supplies the discharge sustain voltage Vs to the plasma display panel drive unit 400. The potential level of the discharge sustain voltage Vs is reduced by a certain amount when the discharge sustain voltage in the form of the pulses outputted from the plasma display panel driving unit 400 increases.

The controlling unit 600 senses the variation of the output voltage, that is, the discharge sustain voltage from the power supply unit 500 and adjusts the output gain of analog-digital converter 200 on the basis of the sensed voltage variation. Thereby, the image signal from the analog-digital converter 200 is reduced in the signal level, and the luminance of the image signal realized in the plasma display panel 450 is decreased. Also, with the decrease of the luminance of the image signal that is realized in the plasma display panel 450, the power consumption becomes correspondingly low. Here, since the controlling unit 600 adjusts the output gain of the analog-digital converter 200 according to the voltage drop caused when the discharge sustain voltage Vs in the form of the pulses from the plasma display panel drive unit 400 is applied to the plasma display panel 450, the response speed is higher as compared with the conventional method for controlling the plasma display panel drive unit 400 depending on the luminance of the digital image signal from the scaler 300.

In an exemplary embodiment, the controlling unit 600 comprises a voltage sensing unit 610, a voltage comparison unit 620, and a gain adjusting unit 630.

The voltage sensing unit 610 includes resistors 611 and 612 connected in series between the discharge sustain voltage Vs from the power supply 500 and a ground. With this configuration, the voltage of node A is varied when the discharge sustain voltage Vs in the form of the pulses from the plasma display panel drive unit 400 to the plasma display panel 450 is varied.

The voltage comparison unit 620 compares the voltage detected in the node A with a reference voltage Vref supplied from the gain adjusting unit 630. The inverting (−) terminal of a comparator 621 is inputted with the voltage detected in the node A, and the non-inverting (+) terminal of the comparator 621 is inputted with a reference voltage Vref supplied from the gain adjusting unit 630. The comparator 621 is of an analog comparator, and compares the reference voltage Vref with the voltage of node A and outputs the difference in these voltages. The output voltage of the comparator 621 is reduced by a certain amount by a resistor 622, and then is outputted to the gain adjusting unit 630. A resistor 623 is connected between node A and the inverting terminal of the comparator 621.

The gain adjusting unit 630 adjusts the output gain of the analog-digital converter 200 with reference to the comparison results of the voltage comparison unit 620.

In an exemplary embodiment, the gain adjusting unit 630 comprises a data storage unit 631, and a microcomputer 632.

The data storage unit 631 stores gain data to be applied to the analog-digital converter 200 based on the output voltage of the voltage comparison unit 620. The gain data is of the configuration in which the output voltage of the analog-digital converter 200 is reduced with the increase of the output voltage of the voltage comparison unit 620.

The microcomputer 632 supplies the reference voltage Vref that has already been stored to the voltage comparison unit 620, and in response to the output voltage of the voltage comparison unit 620, fetches the gain data stored in the data storage unit 631 and provides the fetched gain data to the analog-digital converter 200. As such, when the analog-digital converter 200 converts R, G, and B image signals supplied from the decoder 100 or a personal computer (not shown), it reduces the amplitude of the converted digital image signal by the gain data supplied from the microcomputer 632 and outputs it the scaler 300.

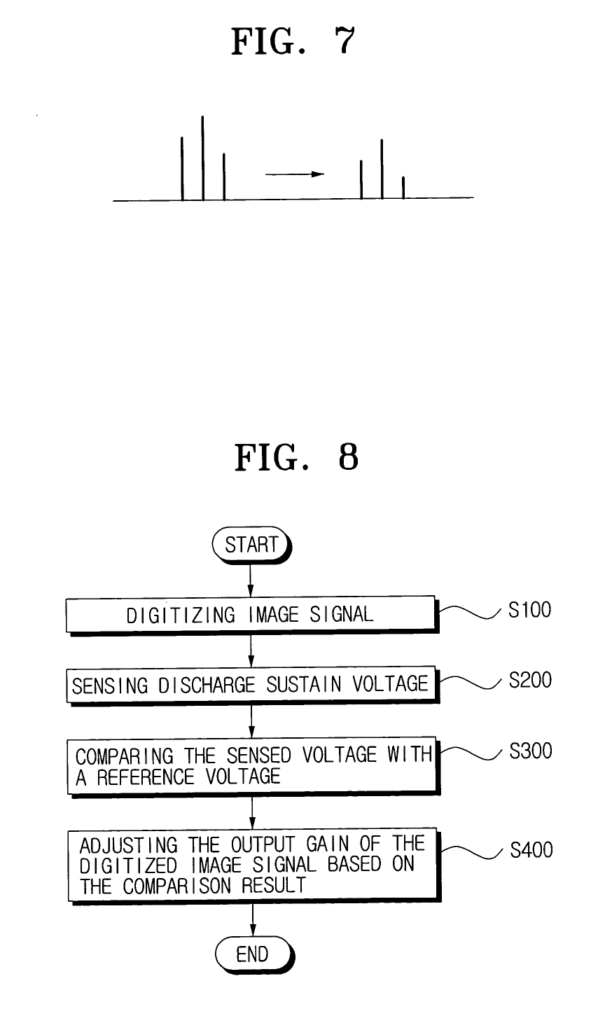

FIG. 7 is a schematic view explaining the operation principle of the gain adjusting unit 630 shown in FIG. 6.

It can be seen from FIG. 7 that the amplitude of the discrete signals outputted from the analog-digital converter 200 is reduced by the gain data supplied from the microcomputer 632. In other words, the image signals supplied from the decoder unit 100 is digitally converted, before the amplitude of the digital image signals is adjusted and outputted it to the scaler 300.

Hereinafter, the operations of the voltage sensing unit 610, the voltage comparison unit 620, and the gain adjusting unit 630 will be explained in detail with reference to a table 1 below:

TABLE 1

| Verf | Va | Vb | gain data |
|---|---|---|---|
| 2.5 V | 3.80 V | 1.2 V | 11111111 |
| | 3.65 V | 1.8 V | 11111111 |
| | 3.30 V | 2.1 V | 11111111 |
| | 2.78 V | 2.3 V | 11111111 |
| | 2.35 V | 3.2 V | 11011101 |
| | 2.10 V | 3.5 V | 11011100 |
| | 1.85 V | 3.9 V | 11011010 |
| | 1.50 V | 4.2 V | 11011001 |
| | 1.35 V | 4.5 V | 11011000 |
| | 0.70 V | 5.0 V | 11010111 |

The reference voltage Vref indicates a voltage supplied from the microcomputer 632 to the comparator 621, Va indicates a voltage applied to the inverting terminal of the comparator 621, and Vb indicates the output voltage of the comparator 621. Here, the minimal output voltage of the comparator 621 is 1.2V and the maximal output voltage of the comparator 621 is 5V, and in the case where the voltages applied to the inverting terminal and the non-inverting terminal of the comparator 621 are the same, the output voltage of the comparator 621 is 3.3V.

First, the voltage sensing unit 610 detects the voltage drop of the discharge sustain voltage Vs. The inverting terminal of the comparator 621 is inputted with the detected voltage Va, and the non-inverting terminal of the comparator 621 is inputted with the Vref. Here, in the case where the detected voltage Va and the Vref are 3.8V and 2.5V, respectively, the output voltage of the comparator 621 is 1.2V. At this time, the microcomputer 632 fetches the gain data 11111111 stored in the data storage unit 631 in response to 1.2V outputted from the comparator 621, and outputs it to the analog-digital converter 200, thereby adjusting the output gain of the analog-digital converter 200. In this case, the output gain of the analog-digital converter 200 is “1” when the gain data is “11111111”, and as indicated in table 1, the gain data increases with the increase of the potential level of the detected voltage Va. In the case where the detected voltage Va is higher than the reference voltage Vref, the gain data outputted from the microcomputer 632 to the analog-digital converter 200 becomes “11111111”. On the other hand, in the case where the detected voltage Va is lower than the reference voltage Vref, that is, the discharge sustain voltage Vs outputted from the power supply unit 500 becomes low due to the high usage frequency of the discharge sustain voltage in the plasma display panel drive unit 400, the output voltage of the comparator 621 is above 3.3V. The microcomputer 632 causes the output gain of the analog-digital converter 200 to be below “1” from the time the output voltage of the comparator 621 is above 3.3V. As such, since the gain adjusting unit adjusts the output gain of the analog-digital converter 200 according to the variation of the output voltage of the power supply 500, it can lower the output gain of the analog-digital converter 200 with the high speed response when increasing in the power consumption in the power supply unit 500 (for example, when the luminance level of the image signal outputted from the plasma display panel drive unit 400 to the plasma display panel 450 is high). Also, as described above, the present plasma display apparatus does not require hardware block for calculating the average luminance level of the digital image signals outputted from the scaler 300.

FIG. 8 is a flow chart showing an exemplary embodiment of the method for controlling the power of the plasma display apparatus according to the present invention.

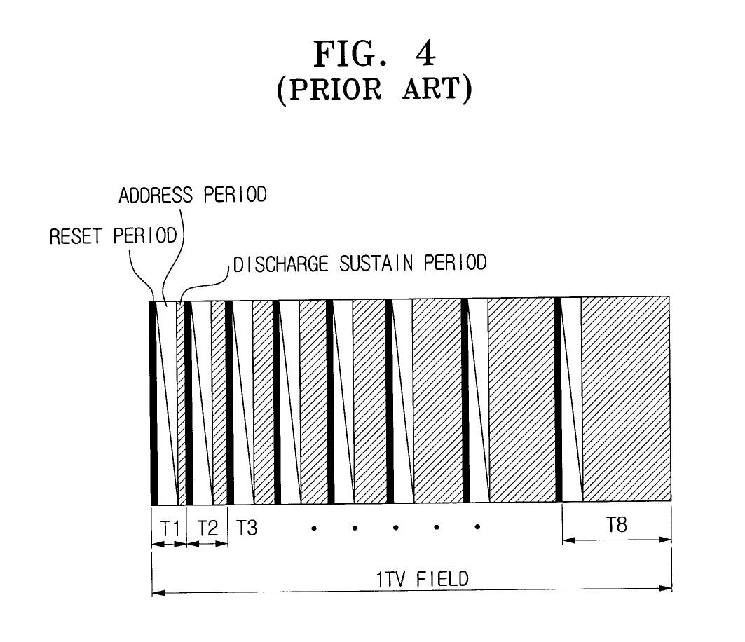

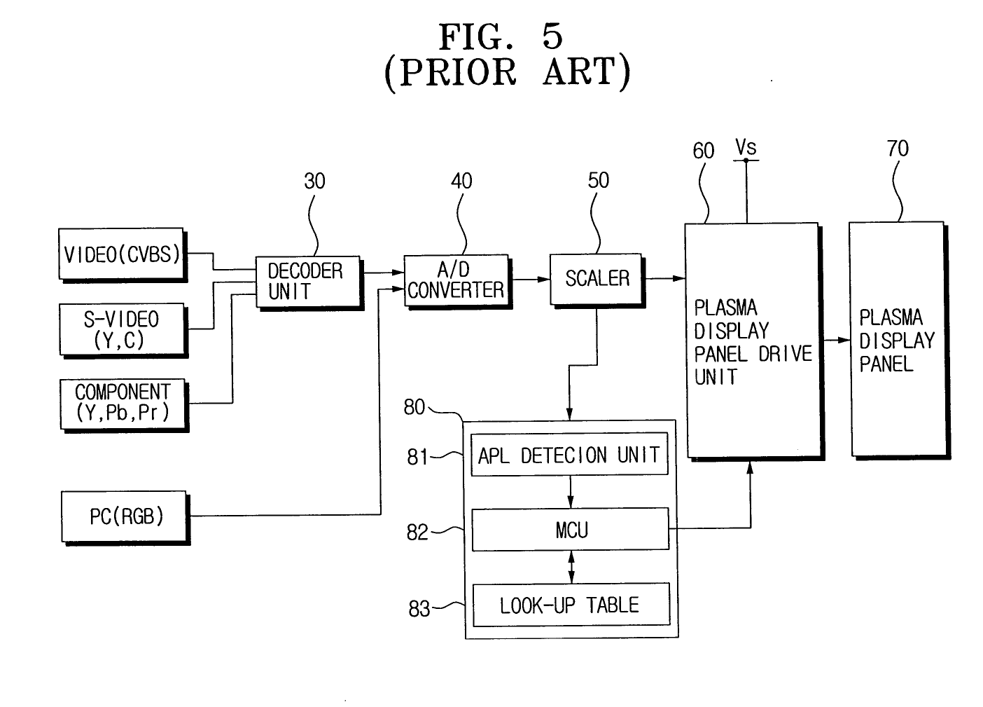

First, the decoder unit 100 is applied with video signal, super-video signal, and component signal, and converts these signals into R, G, and B signals. However, it is not necessary to separately convert the R, G, and B signals outputted from the personal computer (PC). Then, the R, G, and B image signals are digitally converted (S100). The digitally converted image signals are converted to a screen size appropriate to the plasma display panel 450 by the scaler 300, and then applied to the plasma display panel drive unit 400. The plasma display panel drive unit 400 converts the digital image signals outputted from the scaler 300 into scanning pulses and data pulses, and drives the discharge cells constituting the plasma display panel 450 by the converted scanning pulses and data pulses. Here, the number and interval of the on/off operation of the discharge cell are set by selectively applying to the plasma display panel 450 the discharge sustain voltage that is supplied by the plasma display panel drive unit 400 from the power supply unit 500. As described above in FIG. 4, the plasma display panel drive unit 400 increases the luminance of the discharge cell (not shown) by enlarging the total luminescence intervals of the discharge cells constituting the plasma display panel 450, and at this time, the power consumption of the plasma display panel 450 and the plasma display panel drive unit 400 increases. Also, an after image due to the high luminance is caused in the plasma display panel 450

Next, the power supply unit 500 supplies the discharge sustain voltage Vs to the plasma display panel drive unit 400, and when the discharge sustain voltage consumed in the plasma display panel drive unit 400 is increasing, the output voltage Vs becomes low. The voltage sensing unit 610 senses the output voltage Vs outputted from the power supply unit 500 (S200), and the detected voltage Va is compared with the reference Vref set in the microcomputer 632 (S300). As a result of the comparison, if the detected voltage Va is lower than the reference voltage Vref, the output gain of the analog-digital converter 200 is reduced as shown in the table 1 (S400). As such, the power controlling method according to the present invention does not require a separate hardware for calculating the luminance of the image signal restored in the plasma display panel when the luminance of the image signal is high, and adjusts the output gain of the analog-digital converter 200 in response to the variation of the voltage of the power supply unit 500, to have very high-speed response characteristic at the time of controlling the power of the plasma display apparatus.

As described above, the plasma display apparatus according to the present invention can quickly respond and reduce the power consumption occurring when the plasma display panel displays high luminance image signal. Since such a response characteristic is accomplished by sensing the voltage drop of the plasma display panel drive unit and adjusting the output gain of the analog-digital converter 200, the plasma display apparatus according to the present invention dose not require a complex configuration as in the prior art plasma display apparatus.

Although technical spirits of the present invention has been disclosed with reference to the appended drawings and the exemplary embodiments of the present invention corresponding to the drawings has been described, descriptions in the present specification are only for illustrative purpose, not for limiting the present invention.

Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. A plasma display apparatus with low power consumption and high speed response comprising:
a plasma display panel driven by a discharge sustain voltage in the form of pulses;
an analog-digital converter digitizing an image signal and producing a digitized image signal;
a plasma display panel drive unit converting the digitized image signal into scanning pulses and data pulses for driving the plasma display panel and outputting the scanning and data pulses to the plasma display panel;
a power supply unit supplying the discharge sustain voltage to the plasma display panel drive unit; and
a controlling unit adjusting an output gain of the analog-digital converter in response to a variation of the discharge sustain voltage of the power supply unit.

2. The plasma display apparatus of claim 1, wherein the controlling unit comprises:
a voltage sensing unit sensing the variation of the discharge sustain voltage and outputting a sensed voltage;
a voltage comparison unit comparing the sensed voltage from the voltage sensing unit with a predetermined voltage and inputting comparison results; and
a gain adjusting unit adjusting the output gain of the analog-digital converter depending on the comparison results.

3. The plasma display apparatus of claim 2, wherein the voltage sensing unit includes a first resistor and a second resistor connected in series between the discharge sustain voltage and a ground.

4. The plasma display apparatus of claim 3, wherein the voltage comparison unit comprises:
an operational amplifier inputted with a predetermined voltage at its first input terminal;
a third resistor connected between a node commonly connected to the first resistor and the second resistor and a second input terminal of the operational amplifier; and
a fourth resistor connected between an output terminal of the operational amplifier and an input terminal of the gain adjusting unit.

5. The plasma display apparatus of claim 4, wherein the gain adjusting unit comprises:
a data storage unit storing a gain value of the analog-digital converter; and
a microcomputer supplying the predetermined voltage value to the second input terminal of the operational amplifier and outputting the gain value stored in the data storage unit to the analog-digital converter in response to the comparison result of the voltage comparison unit.

6. The plasma display apparatus of claim 5, wherein the operational amplifier includes an analog operational amplifier.

7. The plasma display apparatus of claim 6, wherein the microcomputer stores the predetermined voltage inputted to the operational amplifier.

8. The plasma display apparatus of claim 7, wherein the discharge sustain voltage of the power supply unit is reduced with an increase of a luminance level of the image signal from the plasma display panel drive unit to the plasma display panel.

9. The plasma display apparatus of claim 8, wherein the output gain of the analog-digital converter is reduced with the increase of the luminance level of the image signal inputted to the plasma display panel.

10. The plasma display apparatus of claim 9, further comprising: a scaler positioned between the analog-digital converter and the plasma display panel drive unit and converts the digitized image signal to an image size appropriate to the plasma display panel.

11. A method for controlling a power of a plasma display apparatus comprising a plasma display panel driven by a discharge sustain voltage comprising the steps of:
digitizing an image signal and outputting a digitized image signal; and
adjusting an output gain of the digitized image signal in response to a variation of the discharge sustain voltage.

12. The method for controlling the power of the plasma display apparatus of claim 11, wherein the step of adjusting the output gain comprises the steps of:
sensing the variation of the discharge sustain voltage and outputting a sensed voltage;
comparing the sensed voltage with a predetermined voltage and outputting a comparison result; and
adjusting the output gain of the digitized image signal depending on the comparison result.

13. The method for controlling the power of the plasma display apparatus of claim 11, wherein the discharge sustain voltage is reduced with an increase of a luminance level of the digitized image signal.

14. The method for controlling the power of the plasma display apparatus of claim 11 further comprising converting the digitized image signal to an image size appropriate to the plasma display panel.

15. The plasma display apparatus of claim 1 further comprising a decoder unit receiving an externally inputted image signal and ouputting the image signal to the analog-digital converter.

16. The method for controlling the power of the plasma display apparatus of claim 11 further comprising converting an externally inputted image signal into the image signal and outputting the image signal for digitizing.
